(19) United States
(12) Patent Application Publication
(10) Pub. No.: US 2008/0205393 A1
(43) Pub. Date: Aug. 28, 2008

(54) System and Method for Routing Packets in Portable Internet System

(75) Inventor: Jin Hwa Jeong, Gyeonggi-do (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Posdata, Ltd, Kyeonggi-do (KR)

(21) Appl. No.: 11/916,737

(22) PCT Filed: Jun. 8, 2006
(86) PCT No.: PCT/KR2006/002192

§ 371 Date: Dec. 6, 2007

(30) Foreign Application Priority Data
Jun. 8, 2005 (KR) 1020050048880

(51) Int. Cl. H04L 12/56

(52) U.S. Cl. 370/389

(57) ABSTRACT

The present invention relates to a system and method of routing packets using an IP address in portable Internet, in which an individual IP address is given to a portable Internet terminal attempting to access the portable Internet via a certain radio access station, thereby routing packets without interruption of a packet data service using the IP address. According to the present invention, in a portable Internet system, a routing path for the packet data service is updated in real time using an IP address given to a respective portable Internet terminal while the terminal is moved, thereby continuously using the packet data service without an interruption in the service while the terminal freely moves to a different radio access station. Also, an interface between a radio access station and an access control router system is embodied as an L2 switch to perform real-time packet routing by combining routing and switching technologies, thereby reducing a load for routing packets, quickly routing packets, and reducing a loss of packet data.

### TECHNICAL FIELD

The present invention relates to packet routing in a portable Internet, and more particularly, to a packet routing system and method capable of providing a continuous, uninterrupted packet data service by performing host routing processing with respect to packets communicated by a portable Internet terminal in an environment in which the terminal moves while communicating after accessing via a certain radio access station.

### BACKGROUND ART

Recently, as mobile communication technologies are developed, a portable Internet service enabling high speed wireless Internet at a price as low as with wired Internet, by combining merits of a wireless LAN (WLAN) and a mobile communication network such as a CDMA network, is provided. As an example of the portable Internet service that is a 3.5 generation, there are Wireless Broadband (WiBro) service and Worldwide Interoperability for Micro-wave Access (WiMax) service.

Although the WLAN provides high transmission speed, there is a limitation in a service area, and mobility is not supported. On the other hand, the mobile communication network supports a broad service area and mobility, but transmission speed is low. Accordingly, an aspect of the portable Internet service provides high transmission speed at a level of the WLAN, and a relatively broad service area and mobility at a level of the mobile communication network.

FIG. 1 is a schematic diagram illustrating a configuration of a portable Internet network. Referring to FIG. 1, the portable Internet network includes portable subscriber stations (PSSs) or portable Internet terminals 140, portable Internet radio access stations (RASs) 130 providing a wireless channel to the terminal 140 and mediating connections between the terminal 140 and an access control router (ACR) 120, and the ACR 120 controlling network operations of the respective RAS 130 and the terminal 140 connected to the respective RAS 130, and connecting an edge router of a subscriber network or a core network 110 and the RAS 130.

As described above, the portable Internet network includes a wireless network between the terminal 140 and the RAS 130 and a wired network connecting the RAS 130 and the ACR 120 and connecting a plurality of the ACRs 120 with each other. To comprehensively manage the complex network, the portable Internet system provides a service based on Internet protocol (IP) packet data transmission.

On the other hand, in a conventional art, an IP address is given to a certain network area managed by each router on a network, and packet routing with respect to portable Internet terminals 140 is performed for each IP address. Namely, the respective router on the network notifies an external network of a network address with respect to an area managed by the respective router. The external network routes packets having a destination IP address belonging to the area of the router managing a corresponding area, based on the network address information.

As described above, since the packet routing is not performed based on the respective portable Internet terminal 140 and is performed based on the management area where the respective terminal 140 is located, namely, the network address allocated to the router, the terminal 140 is fixed or mobility is limited to a certain range within the management area. Accordingly, it is impossible to provide the portable Internet service while the terminal 140 freely moves.

### DISCLOSURE OF INVENTION

### Technical Goals

An aspect of the present invention provides a system and method of routing packets, providing continuity and reliability of a portable Internet service to a portable Internet terminal accessing a portable Internet network via a certain radio access station (RAS) and using the service.

An aspect of the present invention also provides a system and method of routing packets, enabling a portable Internet terminal to freely move to a different RAS area and while continuously using an uninterrupted packet data service, by updating a routing path for the packet data service in real time by using an IP address given to the respective portable Internet terminal in a portable Internet system.

An aspect of the present invention also provides a system and method of routing packets, in which, since an interface between an RAS and an access control router (ACR) is embodied as a layer 2 (L2) switch to perform real-time packet routing by combining routing and switching technologies, a load due to packet routing may be reduced and the packets may be more quickly routed, thereby minimizing a loss of packet data.

### TECHNICAL SOLUTIONS

According to an aspect of the present invention, there is provided an access control router system connected to a plurality of radio access stations providing wireless channels to a portable Internet terminal and forwarding Internet packets with respect to the terminal, the system including: a radio access station interface transmitting and receiving the Internet packets with the plurality of radio access stations; a routing table storage unit storing a routing table including an Internet Protocol (IP) address individually given to the terminal and port information of the radio access station interface associated with the terminal; a routing table management unit updating the IP address and the port information; and a routing processing unit transmitting the Internet packets to the terminal or a node on a core network connected to the access control router system.

According to another aspect of the present invention, there is provided a system routing Internet packets transmitted via a portable Internet network, the system including: a plurality of radio access stations providing wireless channels to a portable Internet terminal and exchanging the Internet packet with the terminal via the wireless channel; and an access control router giving an individual IP address to the terminal accessing via the radio access station, storing the IP address, and routing the Internet packets from the terminal on the portable Internet network by referring to the stored IP address.

According to still another aspect of the present invention, there is provided an Internet packet routing method of routing Internet packets on a portable Internet network including an access control router, at least one radio access station connected to the access control router, and a terminal accessing the access control router via the radio access station, the method including: maintaining a routing table including an IP address of the terminal; identifying the terminal and the radio access station when the terminal attempts to access the access control router via the radio access station; updating the IP address of terminal and port information of a radio access station interface corresponding to the radio access station, according to a result of the identification; and transmitting the Internet packets based on the IP address and the port information.

For reference, an IP address mentioned in the specification with respect to the present invention may indicate an independent address given to a respective communication node connected to a portable Internet network. In the present invention, each IP address is given to a respective portable Internet terminal, a routing table maintains each IP address of the respective terminal, and host routing is performed for each terminal instead of each network.

### ADVANTAGEOUS EFFECTS

According to the present invention, a portable Internet terminal may freely move to a different RAS area and simultaneously use a continuous, uninterrupted packet data service by updating a routing path for the packet data service in real time by using an IP address given to the respective portable Internet terminal.

According to the present invention, since an interface between an RAS and an access control router (ACR) is embodied as a Layer 2 (L2) switch to perform real-time packet routing by combining routing and switching technologies, a load due to packet routing may be reduced and the packets may be more quickly routed, thereby minimizing a loss of packet data.

### BRIEF DESCRIPTION OF DRAWINGS

FIG. 1 is a schematic diagram illustrating general connections and layer-relationships between elements of a portable Internet system to which the present invention is applied;

FIG. 2 is a block diagram illustrating internal configurations of a portable Internet access control router and a portable Internet radio access station, according to the present invention;

FIG. 3 is a diagram illustrating an example of a routing table, managed and referred to by the portable Internet access control router according to the present invention;

FIG. 4 is a block diagram illustrating a configuration of hardware of the portable Internet access control router according to the present invention;

FIG. 5 is a block diagram illustrating a configuration of software of the portable Internet access control router according to the present invention; and

FIG. 6 is a flowchart illustrating a method of routing Internet packets, according to the present invention.

### BEST MODE FOR CARRYING OUT THE INVENTION

Hereinafter, exemplary embodiments of configurations of a portable Internet control router and a portable Internet system including the portable Internet control access router and a method of routing Internet packets will be described in detail with reference to the attached drawings.

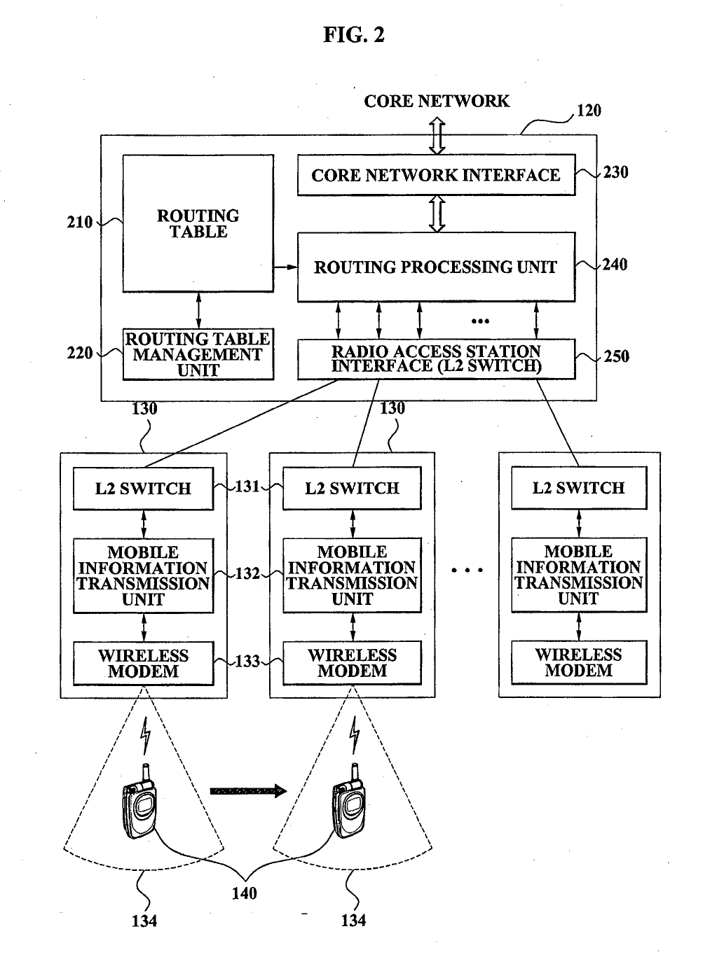

FIG. 2 is a block diagram illustrating internal configurations of a portable Internet access control router (ACR) system 120 and a portable Internet radio access station (RAS), according to the present invention.

Referring to FIG. 2, a portable Internet RAS 130 provides a certain range of a wireless communication area 134 to a respective portable Internet terminal 140 and transmits and receives Internet packet data with the terminal 140 located in the wireless communication area 134 via a wireless channel.

For this, the portable Internet RAS 130 includes a wireless modem 133 for transmitting and receiving packet data with the terminal 140 and a Layer 2 (L2) switch 131 providing L2 level switching for high speed Ethernet communication with the ACR system 120. The L2 switch indicates a switch operating on Layer 2 of the open system interconnection (OSI) 7 layer model. In the L2 switch, since a switching circuit is formed exclusively of hardware, forwarding speed of received packets is high. The L2 switch physically includes an interface for Ethernet 100 Mbps or 1 Gbps such as 1000 base-Tx/1000 base-x.

The wireless modem 133 connected to the L2 switch 131 has a unique media access control (MAC) address as an Ethernet end point. The L2 switch 131 of the RAS 130 is connected to a RAS interface 250 of the ACR system 120 to enable the MAC address of the wireless modem 133 to be reflected on the RAS interface 250 of the ACR system 120, without additional packet processing.

As described above, the ACR system 120 includes the RAS interface 250 transmitting and receiving Internet packets with a plurality of the RASs 130 at high speed. According to an embodiment, the RAS interface 250 of the ACR system 120, connected to the L2 switch 131 of the RAS 130 is also formed of an L2 switch. Accordingly, the RAS interface 250 may transmit Internet packets received from the terminal 140 via the RAS 130 to an interface port corresponding to a respective RAS MAC address or to a core network 110 via the interface port. On the other hand, the RAS interface 250 may transmit Internet packets received from the core network 110 to the terminal 140 via the RAS 130. As shown in FIG. 2, the ACR system 120 includes a core network interface 230 for communication with the core network 110.

As described above, to smoothly exchange IP-based Internet packets between the core network 110 and the RAS 130 via the RAS interface 250, and further, between terminals 140 connected to the RAS 130 via the wireless channel, the ACR system 120 according to the present invention includes a routing table 210 (shown in FIG. 2). In the routing table 210, a host IP address individually given to the terminal 140 and port information of the RAS interface 250 associated with the terminal 140 are stored.

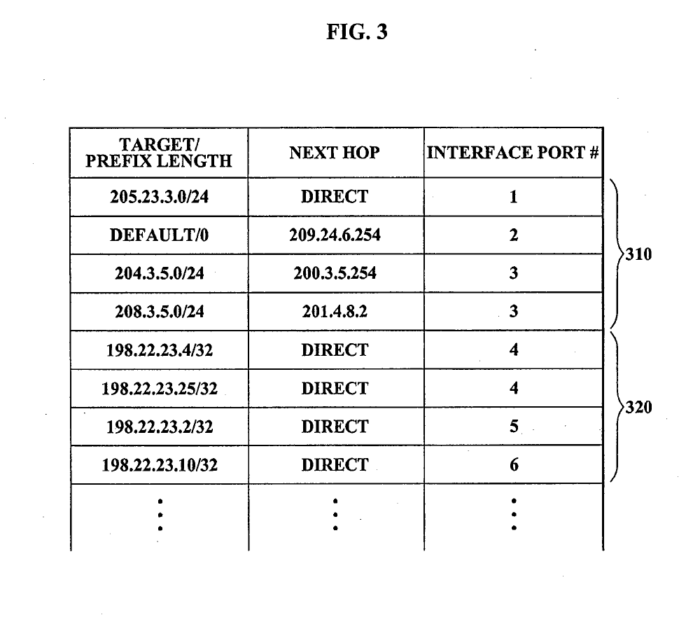

FIG. 3 is a diagram illustrating an example of the routing table 210, managed and referred to by the portable Internet ACR according to the present invention. Referring to FIG. 3, the routing table 210 includes a routing information item 310 associated with the core network 110 and a routing information item 320 associated with the terminal 140. The routing information item 310 associated with the core network 110 includes other ACRs on the core network 110 or routers located on paths to other ACRs and is included in a conventional ACR system.

On the other hand, the routing information item 320 associated with the terminal 140 includes an IP address given to the respective terminal 140 by the ACR system 120 and port information of the RAS interface 150 corresponding to the RAS 130 to which the terminal 140 is connected. Namely, since the ACR system 120 according to the present invention gives an IP address for each terminal 140 and forms the routing table 210 for each IP address, unlike a conventional method of routing based on an address for each network, when the terminal 140 moves out of a wireless communication area of a RAS to which the terminal 140 is previously connected, enters into a wireless communication area of another RAS, and tries to access the ACR system 120 via a new RAS, as shown in FIG. 2, a portable Internet service may be provided without an interruption.

According to an embodiment of the present invention, the routing table 210 is periodically updated at predetermined intervals or randomly when PSS moves to other RAS so routing table should be changed. Namely, a routing table management unit 220 may periodically check for a change of routing information by using a built-in timer. On the other hand, the routing table management unit 220 checks for a change of the routing information and periodically updates the routing table 210 in response to an externally received periodical update message, thereby maintaining the routing table 210.

The routing Internet packets based on the routing table 210 storing the IP address of the terminal 140 is supported by the routing table management unit 220 maintaining or updating the IP address and the port information of the RAS interface 250 and a routing processing unit 240 transmitting Internet packets to the terminal 140 or a node on the core network 110 by referring to the routing table 210.

When the terminal 140 is turned on in the wireless communication area 134 of the RAS 130, the terminal 140 attempts to access the ACR system 120 via the RAS 130 to receive the portable Internet service. The routing table management unit 220 of the ACR system 120, detecting the attempt, gives a unique IP address to the terminal 140 accessing the RAS 130 and adds the given IP address in the routing table 210. When storing the IP address of the terminal 140 in the routing table 210, port information of the RAS interface 250 corresponding to the RAS 130 connected to the terminal 140 is also stored.

When the terminal 140 moves from the RAS 130 to which the terminal 140 is previously connected, becomes connected to the new RAS 130, and attempts to access the portable Internet network via the new RAS 130, the routing table management unit 220 of the ACR 120 checks whether the IP address of the terminal 140 making the trial for accessing is stored in the routing table 210. When the IP address is previously stored in the routing table 210, whether the RAS 130, to which the terminal 140 attempting the access is connected, corresponds to the port information of the RAS interface 250, stored in the routing table 210 together with the IP address, is checked. When the RAS 130 does not correspond to the port information of the RAS interface 250, stored in the routing table 210, the routing table management unit 220 updates the routing table 210 and the routing processing unit 240 routes Internet packets for the terminal 140, accessing via the new RAS 130, by using the updated routing table 210.

Also, the portable Internet RAS 130 according to an embodiment of the present invention communicates with the ACR system 120 by using an L2 switch. Accordingly, without packet processing overhead such as processing IP packets in a tunneling section, a MAC address of the RAS 130 to which the terminal 140 is connected may be directly reflected to the RAS interface 250. Also, a configuration of the RAS 130 and the ACR system 120 using an L2 switch advantageously affects handover processing of the terminal 140. Namely, when performing a handover, a break in continuity of the portable Internet service, which may occur due to overhead of newly allocating network resources for the service in association with the new RAS 130, may be prevented.

In brief, the ACR system 120 performs host routing based on the IP address given to the respective terminal 140, and transmits and receives data packets with the RAS 130 by using an L2 switch, thereby quickly and smoothly performing a handover according to movement of the terminal 140. Also, accordingly, the continuous and reliable portable Internet service may be provided to the moving terminal 140.

According to an embodiment of the present invention, the routing table management unit 220 updates the routing information 310 associated with the core network in addition to the routing information 320 associated with the terminal 140. Namely, the routing table management unit 220 may receive the routing information updated in association with the core network 110 from the core network 110 or mobility management unit 530 and may update routing table 210 if any changes happen in routing table 210.

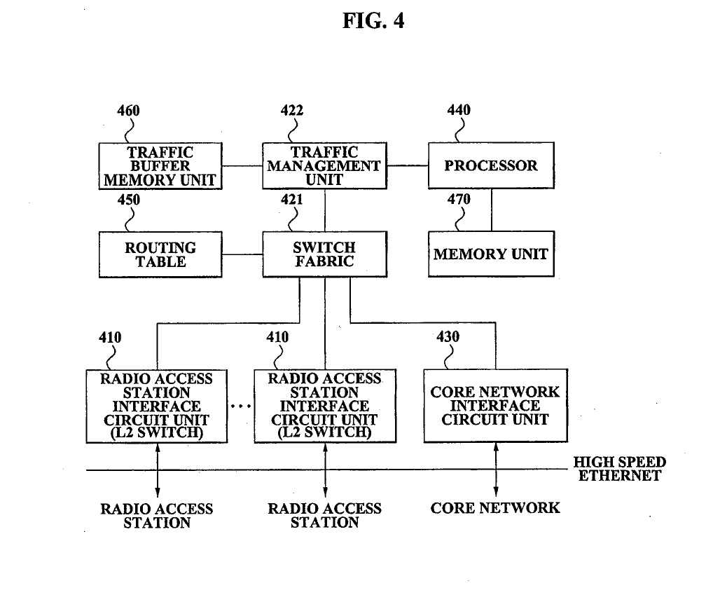

FIG. 4 is a block diagram illustrating a configuration of hardware of the portable Internet ACR system 120 according to the present invention. Referring to FIG. 4, the ACR system 120 includes a plurality of RAS interface circuit units 410 providing high speed Ethernet communication with the RAS 130 and a core network interface circuit unit 430 transmitting data packets or signaling packets to a core network or receiving data packets or signaling packets from the core network.

Also, the ACR system 120 gives an IP address to the terminal 140 attempting to access via a certain RAS interface port, transmits routing information to the core network 110 via the core network interface circuit unit 430, and updates information of the interface port to which the terminal 140 accessing with the individual IP address is connected, in a routing table 450.

Also, the ACR system 120 includes a switch fabric 421 transmitting movement information of the terminal 140 and routing change information of the core network 110 to a traffic management unit 422, the traffic management unit 422 temporarily storing packet data transmitted and received by the terminal 140 in a traffic buffer memory unit 460 and managing corresponding packet data traffic, and a processor 440 giving an IP address to the terminal 140 accessing via the RAS 130 by controlling the switch fabric 421, when movement information of the terminal 140 is transmitted, updating the routing table 450 via the traffic management unit 422 and the switch fabric 421 to perform handover using the IP address of the terminal 140, and when the routing information of the core network is changed, updating the routing table 450 via the traffic management unit 422 and the switch fabric 421.

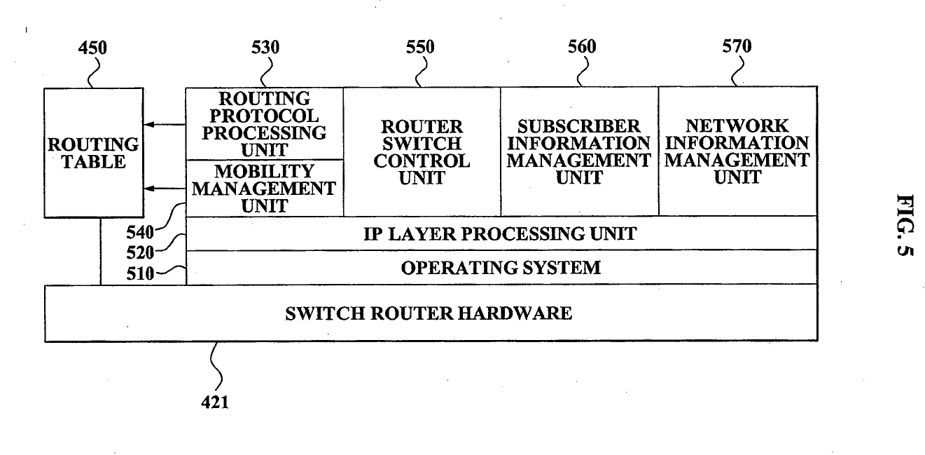

On the other hand, FIG. 5 is a block diagram illustrating a configuration of software of the portable Internet ACR system 120 according to the present invention. The configuration of the software of the ACR system 120, shown in FIG. 5, interacts with switch router hardware, which is the switch fabric 422, and the routing table 450, in the configuration of the hardware shown in FIG. 4.

The ACR system 120 includes an operating system 510 and IP layer processing unit 520 checking IP packets. The ACR system 120 also includes a routing protocol processing unit 530 updating the routing table 450 according to the routing information change of the core network 110, a mobility management unit 540 updating the routing table 450 according to the change in the RAS 130 of the terminal 140, a router switch control unit 550 classifying and transmitting all kinds of control information signals transmitted via the switch fabric 422 to corresponding routing protocol processing unit 530 and mobility management unit 540.

In addition, the ACR system 120 includes a subscriber information management unit 560 managing a MAC address of the L2 switch 131 where the terminal 140 accesses and the IP address given to the terminal 140, and a network information management unit 570 managing information of an interface port to which the respective RAS 130 is connected.

A process of routing Internet packets based on the IP address given to the terminal 140 by using the ACR system 120 having the described configuration will be described below.

Hereinafter, under a circumstance when a first RAS is connected to interface port 1 of the ACR system 120 via the L2 switch 131, and a second RAS is connected to interface port 2 of the ACR system 120 via the L2 switch 131, a packet routing operation is illustrated when handover processing is required as a certain terminal 140 attempts to access via the first RAS and moves to an area managed by the second RAS.

When the terminal 140 attempts to access via the first RAS managing area in which the terminal 140 is located, the ACR system 120 including the first RAS receives the access trial of the terminal 140, gives an IP address to the terminal 140, and transmits routing information to the core network 110 by a routing function.

Also, the ACR system 120 updates the routing table 450 with information of an interface port to which the accessing terminal 140 with an individual IP address is connected, namely, the information includes the IP address of the terminal 140 attempting to access via the first RAS that is connected to the interface port.

The RAS interface circuit unit 410 formed of an L2 switch may automatically recognize a MAC address of the wireless modem 133 of the first RAS where the terminal 140 accesses. Accordingly, the ACR system 120 may recognize relation of the MAC address of the wireless modem 133 where the terminal 140 accesses and the IP address of the terminal 140. The described obtained information is managed by the subscriber information management unit 560.

In this case, the terminal 140 uses a packet data service of the core network 110 by accessing the ACR system 120 via the first RAS. When the terminal 140 moves from the first RAS to the second RAS while using the packet data service, the terminal 140 detects a signal of the second RAS that is a different RAS, and terminal movement information is reported to the first RAS. In this case, the terminal movement information is received via the wireless modem 133 of the first RAS and transmitted to the RAS interface circuit unit 410 of the ACR system 120. On the other hand, the terminal movement information is transmitted to the switch fabric 421, namely, switch router hardware, via the RAS interface circuit unit 410 of the ACR system 120.

The terminal movement information is classified into control channel information in the switch fabric, namely, the switch router hardware 421, of the ACR system 120 and transmitted to the mobility management unit 540 through the router switch control unit 550 corresponding to the processor 440. The mobility management unit 540 recognizes information of an interface port connected to the second RAS to which the terminal 140 moves, based on the terminal movement information by referring to the network information management unit 570 and previously reserves resources.

As the terminal 140 continues moving to the second RAS, terminal 140 determines handover to the area managed by the second RAS, the terminal 140 attempts to access the second RAS and the second RAS allocates wireless resources according to a request of the terminal 140.

At the same time, the mobility management unit 540 of the ACR system 120 accesses the routing table 450 and updates the routing table 450 by deleting the IP address information of the terminal 140 from the interface port 1 and adding the IP address information of the terminal 140 to the interface port 2. Therefore, the packet data service with respect to the terminal 140, namely, the portable Internet service may be uninterrupted and continuously used by changing a packet traffic path from the first RAS to the second RAS.

Also, the RAS interface circuit unit 410 of the ACR system 120, formed of the L2 switch, reduces a load for packet routing and improves speed of performing a handover by simplifying a process of recognizing the MAC address of the wireless modem 133 of the RAS 130 and the IP address of the terminal 140. Accordingly, the router switch control unit 550 of the ACR system 120 may smoothly perform packet routing with respect to the plurality of the terminals 140.

Also, in the present invention, when routing information of the core network 110 is changed, core network routing change information is inputted via the core network interface 230 of the ACR system 120 and transmitted to the switch router hardware 421. The core network routing change information transmitted to the switch router hardware 421 is classified into control information and transmitted to the routing protocol processing unit 530 via the router switch control unit 550. The routing protocol processing unit 530 updates the routing table 450 by the core network routing change information.

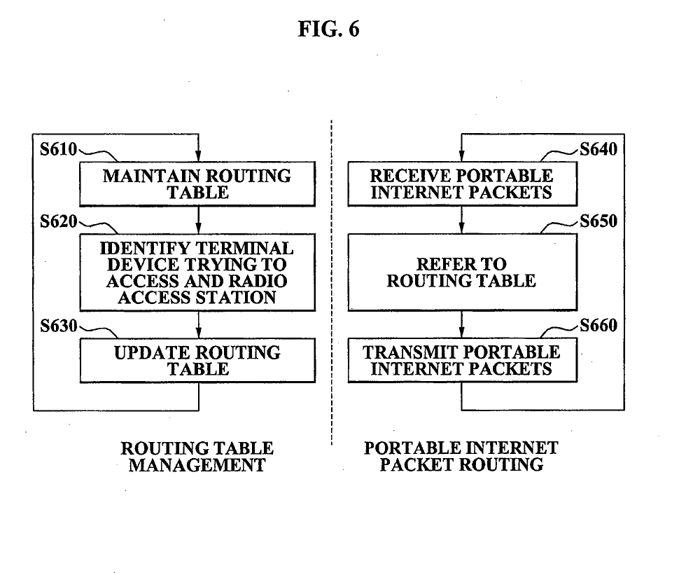

FIG. 6 is a flowchart illustrating a method of routing Internet packets in the portable Internet system including the ACR system 120, the plurality of the RASs 130 connected to the ACR system 120, and the terminals 140 using the portable Internet service via the respective RAS 130, according to the present invention.

Referring to FIG. 6, the method of routing Internet packets, according to the present invention, includes a series of operations of managing a routing table and another series of operations of routing Internet packets referring to the routing table.

The routing table managed by the ACR system 120 stores an IP address given to a respective terminal 140 and port information of a RAS interface corresponding to the respective terminal 140. In operation S610, the routing table including the described information is maintained. In detail, in operation S610, when a new terminal 140 attempts to access a portable Internet network via a certain RAS, an IP address is given to the terminal 140 attempting the access and the given IP address is added to the routing table. In this case, in the routing table, RAS interface port information corresponding to the RAS connected to the terminal 140 is stored together with the IP address of the terminal 140.

In operation S620, when the terminal 140 attempts to access an ACR system via a certain RAS, the terminal 140 and the RAS are identified. The attempt to access includes a case in which a terminal 140 is out of range of an existing RAS and attempts to access a new RAS when performing a handover according to movement of the terminal 140 between the RASs, in addition to an attempt for newly accessing caused by supplying power to the terminal 140.

In operation S620, for example, with respect to the new accessing attempt transmitted from the terminal 140, the terminal 140 may be identified by using the IP address individually given to the respective terminal 140 and the RAS may be identified by using a RAS interface port receiving the accessing trial. Namely, since a MAC address of the RAS to which the terminal 140 is connected may be directly recognized via a RAS interface connected to the respective access station by an L2 switch, in operation S620, the MAC address of the RAS connected to the terminal 140 and the interface port information corresponding to the RAS may be recognized in addition to the IP address of the terminal 140, according to the accessing attempt of the terminal 140.

In operation S630, based on a result of the identification in operation S620, routing information stored in the routing table in association with the connected RAS is replaced by information associated with the new RAS. In detail, interface port information of the connected RAS, stored together with the IP address of the terminal 140, is deleted from the routing table and interface port information of the new RAS is added, thereby updating the routing table.

As described above, the routing table maintained and updated by operations S610 through S630 is used for routing Internet packets. In detail, in operation S640, Internet packets associated with the portable Internet service provided to the terminal 140 are received. Internet packets may be transmitted and received between a portable Internet service provider and the terminal 140, connected via a core network. Also, Internet packets may include data packets and signaling packets. The signaling packets may include resource reservation information associated with quality-of-service (QoS) or routing update information.

In operation S650, routing information is extracted referring to the routing table maintained and updated by operations S610 through S630. In operation S660, Internet packets are transmitted using the extracted routing information. The routing information referred in operation S650 and used in operation S660 includes the IP address of the terminal 140 and port information of the RAS interface corresponding to the terminal 140. Also, the routing information may include routing information of the core network. Namely, to transmit Internet packets received from the terminal 140 to the service provider connected via the core network, the routing information associated with the core network may be referred to. The routing table maintained in operation S610 and updated in operation S630 may include the routing information associated with the core network.

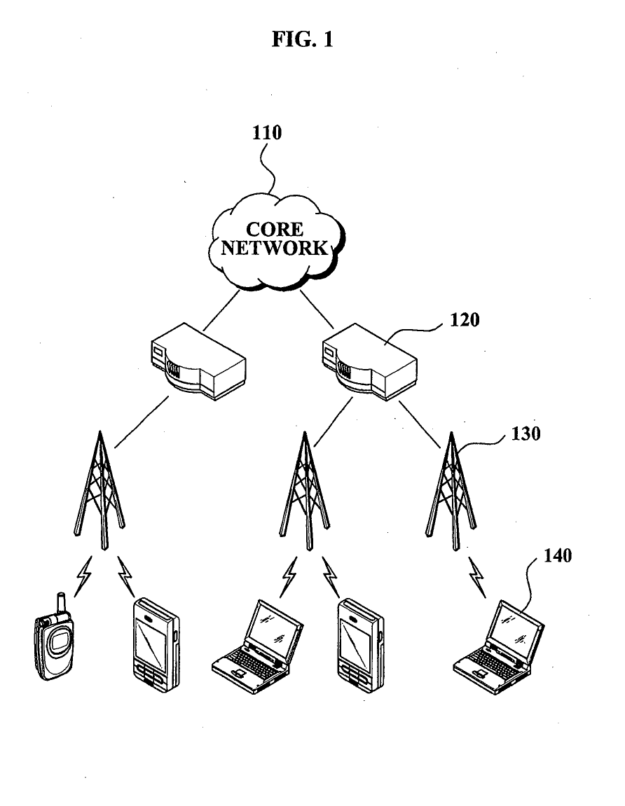

Hitherto, the method of routing Internet packets, according to the present invention, has been described referring to FIG. 6. Since the contents mentioned in the exemplary embodiments described referring to FIGS. 1 through 5 may be applied to the present embodiment as is, hereinafter, detailed description will be omitted.

The method of routing Internet packets, according to the present invention, may be embodied as a program instruction capable of being executed via various computing units and may be recorded in a computer-readable recording medium. The computer-readable medium may include a program instruction, a data file, and a data structure, separately or cooperatively. The program instructions and the media may be those specially designed and constructed for the purposes of the present invention, or they may be of the kind well-known and available to those skilled in the art of computer software arts. Examples of the computer-readable media include magnetic media (e.g., hard disks, floppy disks, and magnetic tapes), optical media (e.g., CD-ROMs or DVD), magneto-optical media (e.g., optical disks), and hardware devices (e.g., ROMs, RAMs, or flash memories, etc.) that are specially configured to store and perform program instructions. The media may also be transmission media such as optical or metallic lines, wave guides, etc. including a carrier wave transmitting signals specifying the program instructions, data structures, etc. Examples of the program instructions include both machine code, such as produced by a compiler, and files containing high-level language codes that may be executed by the computer using an interpreter. The hardware elements above may be configured to act as one or more software modules for implementing the operations of this invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An access control router system connected to a plurality of radio access stations providing wireless channels to a portable Internet terminal and routing Internet packets with respect to the terminal, the system comprising:
a radio access station interface transmitting and receiving the Internet packets with the plurality of radio access stations;
a routing table storage unit storing a routing table including an Internet Protocol (IP) address individually given to the terminal, port information of the radio access station interface associated with the terminal and network information;
a routing table management unit updating the IP address and the port information; and
a routing processing unit transmitting the Internet packets to the terminal or a node on a core network connected to the access control router system.

2. The system of claim 1, wherein the radio access station interface comprises a Layer 2 (L2) switch.

3. The system of claim 1, wherein:
the routing table stores routing information associated with the core network; and
the routing table management unit updates the routing information associated with the core network.

4. The system of claim 1, wherein the routing table management unit updates the IP address or the port information when the terminal tries to access the access control router system.

5. The system of claim 1, wherein the routing table management unit updates the IP address or the port information when the radio access station connected to the terminal is changed.

6. The system of claim 1, wherein:
the radio access station interface comprises a plurality of Ethernet ports; and
the port information comprises port identification information of a port corresponding to each of the plurality of radio access stations among the plurality of Ethernet ports.

7. The system of claim 1, wherein the routing table is periodically updated at predetermined intervals or randomly updated when the terminal moves.

8. A system routing Internet packets transmitted via a portable Internet network, the system comprising:
a plurality of radio access stations providing a wireless channel to a portable Internet terminal and exchanging the Internet packet with the terminal via the wireless channel; and
an access control router giving an individual IP address to the terminal accessing via the radio access station, storing the IP address, and routing the Internet packets from the terminal on the portable Internet network by referring to the stored IP address.

9. The system of claim 8, wherein the radio access station comprises:
a wireless modem having an Ethernet Media Access Control (MAC) address and transmitting and receiving the Internet packets with the terminal located in a management domain of a certain range;
a switch interface providing Ethernet communication with the access control router; and
a movement information transmission unit transmitting movement information of the terminal, received via the wireless modem, to the access control router via the switch interface.

10. The system of claim 9, wherein the switch interface transmits the MAC address to the access control router.

11. The system of claim 8, wherein the access control router comprises:
a switch interface providing Ethernet communication with the plurality of the radio access stations;
a routing table storage unit storing a routing table including an individual IP address of the terminal accessing the access control router via the radio access station;
a routing table management unit updating the IP address of the terminal and port information of the switch interface associated with the terminal; and
a routing processing unit routing the Internet packets from the radio access station by referring to the routing table.

12. The system of claim 9, wherein the switch interface comprises an L2 switch.

13. The system of claim 8, wherein the access control router comprises:
a subscriber information management unit managing a MAC address of a radio access station channel connecting the terminal to the radio access station and the IP address given to the terminal; and
a network information management unit managing the port information of the switch interface corresponding to the radio access station, and
the access control router routes the Internet packets by referring to the IP address and the port information.

14. The system of claim 13, wherein the access control router further comprises:
a routing protocol processing unit performing processing according to a change of routing information of a core network and updating the changed routing information in the routing table when the routing information is changed; and
a mobility management unit updating the routing table when the radio access station connected to the terminal is changed due to movement of the terminal.

15. An Internet packet routing method of routing Internet packets on a portable Internet network including an access control router, at least one radio access station connected to the access control router, and a terminal accessing the access control router via the radio access station, the method comprising:
maintaining a routing table including an IP address of the terminal;
identifying the terminal and the radio access station when the terminal attempts to access the access control router via the radio access station;
updating the IP address of terminal and port information of a radio access station interface corresponding to the radio access station, according to a result of the identification; and
transmitting the Internet packets based on the IP address and the port information.

16. The method of claim 15, wherein the result of the identification comprises at least one of the IP address of the terminal and an Ethernet MAC address of the radio access station where the terminal is connected.

17. A computer-readable recording medium in which a program for executing the method according to any one of claims 15 is recorded.

18. A computer-readable recording medium in which a program for executing the method according to any one of claims 16 is recorded.

19. The system of claim 11, wherein the switch interface comprises an L2 switch.
